(19) United States
(12) Patent Application Publication
(10) Pub. No.: US 2025/0131744 A1
(43) Pub. Date: Apr. 24, 2025

(54) LANE-DIVIDING LINE RECOGNITION APPARATUS FOR VEHICLE

(71) Applicant: SUBARU CORPORATION, Tokyo (JP)

(72) Inventors: Ryo NOTO, Tokyo (JP); Kentaro Nozu, Tokyo (JP); Hitoshi Niwa, Tokyo (JP)

(73) Assignee: SUBARU CORPORATION, Tokyo (JP)

(21) Appl. No.: 18/911,263

(22) Filed: Oct. 10, 2024

(30) Foreign Application Priority Data
Oct. 20, 2023 (JP) 2023-181358

(51) Int. Cl. G06V 20/56; G06V 10/77; G06V 10/776

(52) U.S. Cl. CPC G06V 20/588; G06V 10/7715; G06V 10/776

(57) ABSTRACT

A lane-dividing line recognition apparatus for a vehicle includes a processor that calculates relative coordinates of a tentative complementary point extracted from data on a lane-dividing line recognized in each predetermined cycle, based on image of a traveling environment in front of the vehicle, calculates a first lane-dividing line complementary point, based on the relative coordinates and traveling information on the vehicle, and calculates a second lane-dividing line complementary point, based on the relative coordinates and absolute position data on the vehicle. The processor further acquires a first evaluation value usable for evaluating accuracy in detecting the traveling information on the vehicle, and acquires a second evaluation value usable for evaluating accuracy in detecting the absolute position data on the vehicle, and integrates the first lane-dividing line complementary point and the second lane-dividing line complementary point, using reliability calculated based on the first evaluation value and the second evaluation value.

### CROSS-REFERENCE TO RELATED APPLICATIONS

The present application claims priority from Japanese Patent Application No. 2023-181358 filed on Oct. 20, 2023, the entire contents of which are hereby incorporated by reference.

### BACKGROUND

### Technical Field

The disclosure relates to a lane-dividing line recognition apparatus to be applied to a vehicle and configured to recognize a lane dividing line.

### Related Art

Recent vehicles such as automobiles are equipped with a driver assistance apparatus. The driver assistance apparatus implements driver assistance control by combining various kinds of control such as adaptive cruise control (ACC), active lane keep centering (ALKC) control, and emergency lane keep assist (ELKA) control, as appropriate.

In such driver assistance control, it is important to recognize lane dividing lines on lanes, such as an own-vehicle traveling lane and an adjacent lane, in real time. The lane dividing lines are to be recognized in an area in front of an own vehicle and an area behind the own vehicle. Japanese Unexamined Patent Application Publication (JP-A) No. 2012-164287, for example, discloses a technique of generating complementary data on a lane dividing line in the area behind the own vehicle, based on a history of candidate lane-dividing line points detected in the area in front of the own vehicle by an in-vehicle camera, a yaw rate of the own vehicle, and a vehicle speed of the own vehicle, and other factors.

### SUMMARY

An aspect of the disclosure provides a lane-dividing line recognition apparatus for a vehicle. The lane-dividing line recognition apparatus includes a lane-dividing line recognizer, a relative coordinate calculator, a first complementary point calculator, a first evaluation value acquirer, a second complementary point calculator, a second evaluation value acquirer, and a complementary point integrator. The lane-dividing line recognizer is configured to recognize data on a lane dividing line ahead of the vehicle in each of predetermined cycles, based on sensing data on a traveling environment in front of the vehicle. The relative coordinate calculator is configured to extract a tentative complementary point from the data on the lane dividing line in each of the predetermined cycles, and calculate relative coordinates of the tentative complementary point with respect to the vehicle. The first complementary point calculator is configured to update the relative coordinates of the tentative complementary point having been calculated, based on traveling information on the vehicle in each of the predetermined cycles, and calculate a first lane-dividing line complementary point usable for complementing the data on the lane dividing line by data on a lane dividing line behind the vehicle. The first evaluation value acquirer is configured to acquire a first evaluation value usable for evaluating accuracy in detecting the traveling information in each of the predetermined cycles. The second complementary point calculator is configured to calculate absolute position data on the tentative complementary point from the relative coordinates of the tentative complementary point, based on absolute position data on the vehicle measured using signals from positioning satellites in each of the predetermined cycles, and calculate a second lane-dividing line complementary point usable for complementing the data on the lane dividing line by the data on the lane dividing line behind the vehicle, from the absolute position data on the tentative complement point having been extracted and the absolute position data on the vehicle currently measured. The second evaluation value acquirer configured to acquire a second evaluation value usable for evaluating accuracy in detecting the absolute position data on the vehicle in each of the predetermined cycles. The complementary point integrator is configured to integrate the first lane-dividing line complementary point and the second lane-dividing line complementary point corresponding to each other, using reliability calculated based on the first evaluation value and the second evaluation value.

An aspect of the disclosure provides a lane-dividing line recognition apparatus for a vehicle. The lane-dividing line recognition apparatus includes a processor configured to: recognize data on a lane dividing line ahead of the vehicle in each of predetermined cycles, based on sensing data on a traveling environment in front of the vehicle; extract a tentative complementary point from the data on the lane dividing line in each of the predetermined cycles, and calculate relative coordinates of the tentative complementary point with respect to the vehicle; update the relative coordinates of the tentative complementary point having been calculated, based on traveling information on the vehicle in each of the predetermined cycles, and calculate a first lane-dividing line complementary point usable for complementing the data on the lane dividing line by data on a lane dividing line behind the vehicle; acquire a first evaluation value usable for evaluating accuracy in detecting the traveling information in each of the predetermined cycles; calculate absolute position data on the tentative complementary point from the relative coordinates of the tentative complementary point, based on absolute position data on the vehicle measured using signals from positioning satellites in each of the predetermined cycles, and calculate a second lane-dividing line complementary point usable for complementing the data on the lane dividing line by the data on the lane dividing line behind the vehicle, from the absolute position data on the tentative complement point having been extracted and the absolute position data on the vehicle currently measured; acquire a second evaluation value usable for evaluating accuracy in detecting the absolute position data on the vehicle in each of the predetermined cycles; and integrate the first lane-dividing line complementary point and the second lane-dividing line complementary point corresponding to each other, using reliability calculated based on the first evaluation value and the second evaluation value.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to explain the principles of the disclosure.

FIG. 1 is a block diagram illustrating a schematic configuration of a driver assistance apparatus according to one example embodiment.

FIG. 2 is an explanatory diagram illustrating sensing areas of a stereo camera and a radar.

FIG. 3 is an explanatory diagram illustrating candidate lane-dividing line points detected in a traveling environment image.

FIG. 4 is an explanatory diagram illustrating an exemplary change in brightness along a search line.

FIG. 5 is an explanatory diagram illustrating exemplary distribution of the candidate lane-dividing line points on a coordinate system in a real space and an exemplary lane-dividing line approximate curve.

FIG. 6 is an explanatory diagram illustrating a tentative complementary point extracted from each lane-dividing line approximate curve.

FIG. 7 is an explanatory diagram illustrating a relative coordinate system in a current frame and a relative coordinate system in a first previous frame.

FIG. 8 is an explanatory diagram illustrating a current moving distance of an own vehicle viewed from the relative coordinate system in the first previous frame.

FIG. 9 is an explanatory diagram illustrating the relative coordinate system in the first previous frame and a relative coordinate system in a second previous frame.

FIG. 10 is an explanatory diagram illustrating a moving distance of the own vehicle in the first previous frame viewed from the relative coordinate system in the second previous frame.

FIG. 11 is an explanatory diagram illustrating a tentative complementary point in an nth-previous frame that is axially converted in the same axial direction as that of the relative coordinate system in the current frame.

FIG. 12 is an explanatory diagram illustrating a distance to an own vehicle position viewed from the relative coordinate system in the n-th previous frame.

FIG. 13 is an explanatory diagram illustrating a distance to the own vehicle position viewed from a tentative complementary point on the relative coordinate system in the n-th previous frame.

FIG. 14 is an explanatory diagram illustrating a distance to the tentative complementary point in the n-th previous frame viewed from the own vehicle position.

FIG. 15 is an explanatory diagram illustrating a relative coordinate system having axial directions along lateral and longitudinal directions of the own vehicle, and a relative coordinate system having axial directions along cardinal directions.

FIG. 16 is an explanatory diagram illustrating the coordinates of the tentative complementary point obtained as a result of conversion from the coordinates on the relative coordinate system having axial directions along the lateral and longitudinal directions of the own vehicle into the coordinates on the relative coordinate system having axial directions along the cardinal directions.

FIG. 17 is an explanatory diagram illustrating a relation between absolute position data on the own vehicle and absolute position data on the tentative complementary point.

FIG. 18 is an explanatory diagram illustrating an absolute position of the own vehicle and an absolute position of the tentative complementary point in each frame.

FIG. 19 is an explanatory diagram illustrating a second lane-dividing line complementary point calculated from the absolute position data on the tentative complementary point.

FIG. 20 is an explanatory diagram illustrating a lane-dividing line complementary point calculated by integrating a first lane-dividing line complementary point and the second lane-dividing line complementary point.

FIG. 21 is a flowchart of an exemplary routine of the recognition of a lane dividing line.

FIG. 22 is a flowchart of an exemplary sub-routine of the calculation of the first lane-dividing line complementary point.

FIG. 23 is a flowchart of an exemplary sub-routine of the calculation of the second lane-dividing line complementary point.

### DETAILED DESCRIPTION

A yaw rate detected by a yaw rate sensor can include a detection error due to factors related to the performance of the yaw rate sensor itself and a traveling state of an own vehicle. Such a detection error of the yaw rate influences candidate lane-dividing line points to be generated as complementary data by the technique disclosed in JP-A No. 2012-164287. The influence of the detection error of the yaw rate increases as the candidate lane-dividing line point generated as the complementary data moves farther from the own vehicle.

It is desirable to provide a lane-dividing line recognition apparatus for a vehicle that makes it possible to generate accurate complementary data on a lane-dividing line in an area behind an own vehicle, based on candidate lane-dividing line points in an area in front of the own vehicle.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

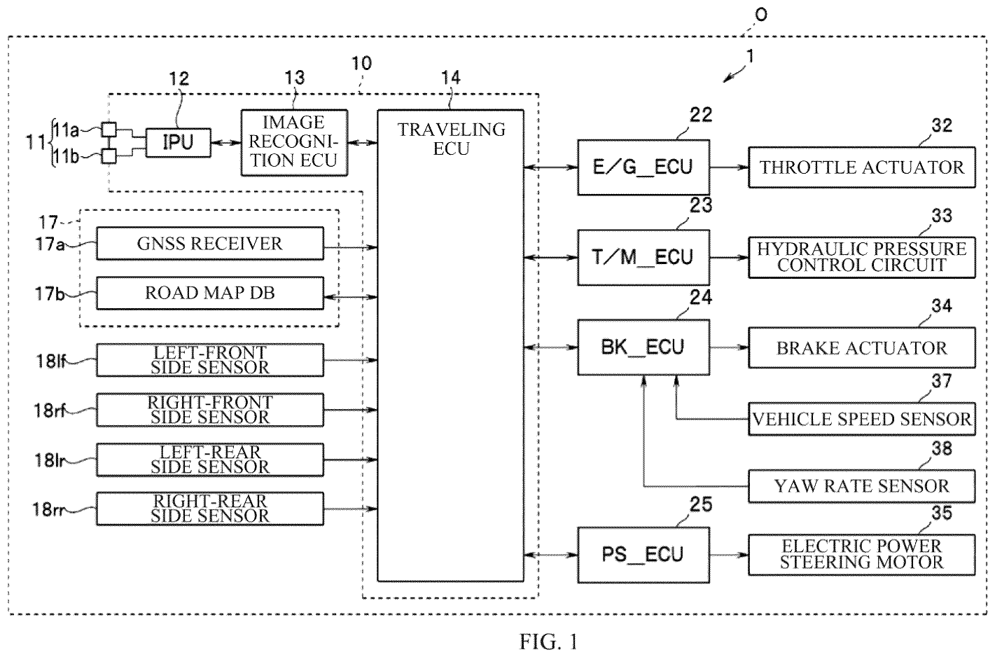

FIG. 1 schematically illustrates an exemplary configuration of a driver assistance apparatus 1 for a vehicle (hereinafter referred to as an own vehicle O) according to an example embodiment of the disclosure.

Referring to FIG. 1, the driver assistance apparatus 1 may include a camera unit 10. The camera unit 10 may be fixed to an upper front center inside a vehicle compartment of the own vehicle O, for example.

The camera unit 10 may include a stereo camera 11 serving as an imager, an image processing unit (IPU) 12, an image recognition ECU 13, and a traveling ECU 14.

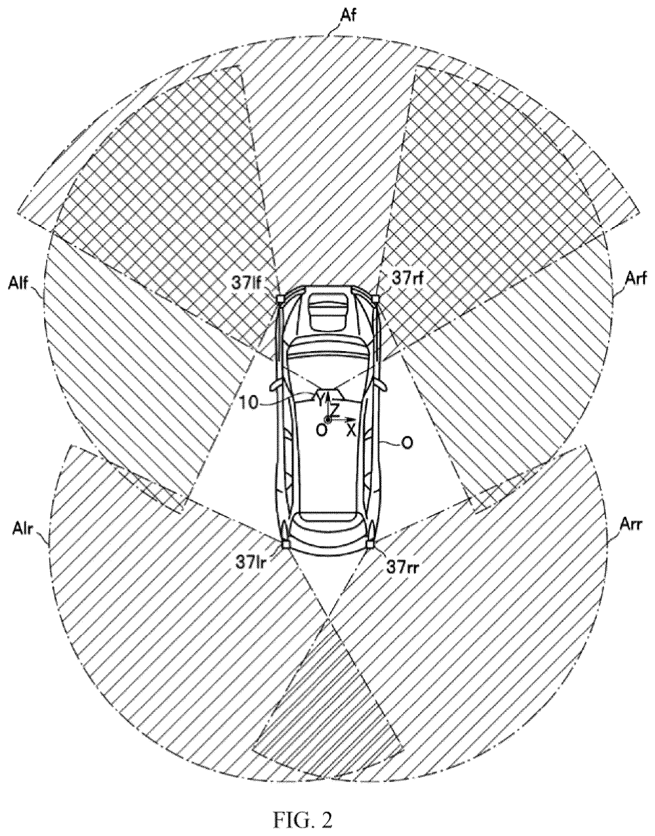

The stereo camera 11 may include a main camera 11a and a subsidiary camera 11b as sensors. The main camera 11a and the subsidiary camera 11b may each include an imaging device such as a complementary metal-oxide-semiconductor (CMOS). The main camera 11a and the subsidiary camera 11b may be disposed laterally symmetrical about the center of a vehicle-width direction. The main camera 11a and the subsidiary camera 11b disposed in such a manner as described above may perform stereo imaging by capturing images of a traveling environment in an outside-vehicle frontal area Af (see FIG. 2) from different lines of sight and in predetermined imaging cycles synchronized with each other.

The IPU 12 may perform predetermined image processing on the images of the traveling environment captured by the stereo camera 11, to thereby detect edges of various objects in the image. The objects may be, but not limited to, three-dimensional objects or lane dividing lines on a road surface. The IPU 12 may further calculate distance data from the amount of positional shift of the same edge between the right and left images. The IPU 12 may thereby generate distance image information including the distance data.

Based on the distance image information received from the IPU 12, the image recognition ECU 13 recognizes a lane dividing line that divides a road into lanes. In some embodiments, the image recognition ECU 13 may calculate a curvature [1/m] of each of right and left lane dividing lines that define each lane of the road, and the width between the right and left lane dividing lines (a lane width). The image recognition ECU 13 may further calculate the lane width from a difference between the curvatures of the right and left lane dividing lines. Through the recognition of the lane dividing line as described above, the image recognition ECU 13 may recognize lanes of the road, including a lane on which the own vehicle O is traveling (hereinafter referred to as an own-vehicle traveling lane). Note that the recognition of the lane dividing line will be described in detail later.

The image recognition ECU 13 may perform predetermined pattern matching, based on the distance image information, to thereby recognize three-dimensional objects present on the road. Non-limiting examples of the three-dimensional objects may include a guardrail and a curb extending along the road, and other vehicles traveling around the own vehicle O on the road. In some embodiments, the recognition of the three-dimensional objects by the image recognition ECU 13 may involve recognition of a kind of a three-dimensional object, a distance to the three-dimensional object, a speed of the three-dimensional object, and a relative speed between the three-dimensional object and the own vehicle O.

Various kinds of data recognized by the image recognition ECU 13 may be sent, as traveling environment information, to the traveling ECU 14.

The traveling ECU 14 may be a control unit that controls an overall operation of the driver assistance apparatus 1.

Various sensors, such as a locator unit 17, a left-front side sensor 18lf, a right-front side sensor 18rf, a left-rear side sensor 18lr, and a right-rear side sensor 18rr may be coupled to the traveling ECU 14.

Various control units, such as an engine control unit (E/G_ECU) 22, a transmission control unit (T/M_ECU) 23, a brake control unit (BK_ECU) 24, and a power steering control unit (PS_ECU) 25 may be coupled to the traveling ECU 14, via an in-vehicle communication line such as a controller area network (CAN).

The left-front side sensor 18lf and the right-front side sensor 18rf may each include a radar such as a millimeter-wave radar. The left-front side sensor 18lf and the right-front side sensor 18rf may be disposed on a left side and a right side of a front bumper of the own vehicle O, respectively, for example. The left-front side sensor 18lf and the right-front side sensor 18rf may detect, as the traveling environment information, three-dimensional objects present in respective areas Alf and Arf illustrated in FIG. 2 that are difficult to be recognized from the image captured by the stereo camera 11. The area Alf may include a diagonally left-front area and a left side area with respect to the own vehicle O. The area Arft may include a diagonally right-front area and a right side area with respect to the own vehicle O.

The left-rear side sensor 18lr and the right-rear side sensor 18rr may each include a radar such as a millimeter-wave radar. The left-rear side sensor 18lr and the right-rear side sensor 18rr may be disposed on a left side and a right side of a rear bumper of the own vehicle O, respectively, for example. The left-rear side sensor 18lr and the right-rear side sensor 18rr may detect, as the traveling environment information, three-dimensional objects present in respective areas Alr and Arr illustrated in FIG. 2 that are difficult to be recognized by the left-front side sensor 18lf and the right-front side sensor 18rf. The area Alf may include a diagonally left-side area and a left-rear area with respect to the own vehicle O. The area Arr may include a diagonally right-side area and a right-rear area with respect to the own vehicle O.

In a case where these sensors 18 each include a millimeter-wave radar, the millimeter-wave radar may detect a three-dimensional object such as a vehicle traveling in parallel to the own vehicle O or a vehicle traveling behind the own vehicle O by analyzing a reflection wave obtained as a result of reflection of an electric wave outputted to and reflected from the object. In some embodiments, each of the sensors 18 may detect, as three-dimensional object information, a lateral width of the three-dimensional object, a position of a representative point of the three-dimensional object (a relative distance to the own vehicle O), and a speed of the three-dimensional object.

In one embodiment, the left-front side sensor 18lf, the right-front side sensor 18rf, the left-rear side sensor 18lr, and the right-rear side sensor 18rr may each serve as a “traveling environment recognizer” that recognizes the traveling environment information on the traveling environment outside the own vehicle O.

The locator unit 17 may include a GNSS receiver 17a and a high-resolution map database (road map DB) 17b.

The GNSS receiver 17a may receive positional signals from positioning satellites. Based on the positional signals, the GNSS receiver 17a may measure a current position (e.g., latitude, longitude, azimuth angle) of the own vehicle O. Hereinafter, the position of the own vehicle O may be also referred to as an own vehicle position.

The road map DB 17b may be a mass storage medium such as a hard disk drive (HHD). The road map DB 17b may hold high-resolution road map data (dynamic map). In some embodiments, the road map data may include lane data necessary for automated driving. Non-limiting examples of the lane data may include data on the width of a lane, data on the coordinates of a central position of the lane, data on a traveling azimuth angle of the lane, and data on a speed limit. The lane data may be stored at intervals of several meters for each lane on the road map. The road map DB 17b may further include traffic light data or other kinds of data associated with the lane data.

The road map DB 17b may send the traveling ECU 14 the road map data covering a predetermined area around the own vehicle position measured by the GNSS receiver 17a, as the traveling environment information, in response to a request signal from the traveling ECU 14.

In one embodiment, the locator unit 17 may serve as a “traveling environment recognizer”.

A device such as a throttle actuator 32 may be coupled to an output side of the E/G_ECU 22. The throttle actuator 32 may be an electronically-controlled throttle. Various sensors including a non-illustrated accelerator sensor may be coupled to an input side of the E/G_ECU 22.

The E/G_ECU 22 may control driving of the throttle actuator 32 and other devices, based on control signals from the traveling ECU 14, detection signals from the various sensors, or other signals. The E/G_ECU 22 may thereby adjust an in-take air amount of an engine of the own vehicle O, to thereby generate a desired engine output. The E/G_ECU 22 may send signals indicating results of detection by the various sensors, including an accelerator position, to the traveling ECU 14.

A hydraulic pressure control circuit 33 may be coupled to an output side of the T/M_ECU 23. Various sensors including a non-illustrated shift position sensor may be coupled to an input side of the T/M_ECU 23. The T/M_ECU 23 may control driving of the hydraulic pressure control circuit 33 and other devices, based on an engine torque signal estimated by the E/G_ECU 22 and detection signals from the various sensors. The T/M_ECU 23 may thereby cause a frictional engagement element, a pulley, and other devices in an automatic transmission to operate, thereby changing the engine output at a desired speed ratio. The T/M_ECU 23 may send signals detected by the various sensors, including a signal indicating a shift position, to the traveling ECU 14.

A brake actuator 34 may be coupled to an output side of the BK_ECU 24. The brake actuator 34 may adjust a brake fluid pressure to be sent to a brake wheel cylinder provided to each wheel. A vehicle speed sensor 37 and a yaw rate sensor 38 may be coupled to an input side of the BK_ECU 24. In one embodiment, the vehicle speed sensor 37 may serve as a “vehicle speed detector”. In one embodiment, the yaw rate sensor 38 may serve as a “yaw rate detector”. Further, various sensors including a non-illustrated brake pedal sensor and a non-illustrated longitudinal acceleration sensor may be coupled to the input side of the BK_ECU 24. The vehicle speed sensor 37 may detect an own vehicle speed V of the own vehicle O. The yaw rate sensor 38 may detect a yaw rate ω acting on the own vehicle O.

The BK_ECU 24 may control driving of the brake actuator 34 and other devices, based on control signals from the traveling ECU 14 and detection signals from the various sensors. The BK_ECU 24 may thereby generate a brake force to be used in forcible braking control and yaw rate control at each wheel of the own vehicle O, as appropriate. The BK_ECU 24 may send signals indicating, for example, a brake operational state, a yaw rate, a lateral acceleration, and an own vehicle speed that are detected by the various sensors, to the traveling ECU 14.

An electric power steering motor 35 may be coupled to an input side of the PS_ECU 25. The electric power steering motor 35 may apply steering torque generated by a rotational force of a motor in a steering mechanism. Further, various sensors including a steering torque sensor and a steering angle sensor may be coupled to the input side of the PS_ECU 25.

The PS_ECU 25 may control driving of the electric power steering motor and other devices, based on control signals from the traveling ECU 14 and detection signals from the various sensors. The PS_ECU 25 may thereby generate steering torque to be applied to the steering mechanism. Further, the PS_ECU 25 may send the traveling ECU 14 signals indicating, for example, steering torque and a steering angle detected by the various sensors.

The traveling ECU 14 may perform driver assistance control by transmitting various control signals to the E/G_ECU 22, the T/M_ECU 23, the BK_ECU 24, and the PS_ECU 25.

The driver assistance control may be implemented by combining adaptive cruise control (ACC), active lane keep centering (ALKC) control, emergency lane keep assist (ELKA) control, and automatic lane changing (ALC) control, as appropriate.

The ACC may be implemented by selectively executing following traveling control and constant-speed traveling control. In some embodiments, the traveling ECU 14 may execute the following traveling control when a preceding vehicle traveling ahead of the own vehicle O is recognized based on the traveling environment information. In the following traveling control, the traveling ECU 14 may perform acceleration or deceleration control depending on a vehicle speed of the preceding vehicle and other factors, to thereby maintain a target inter-vehicular distance. When no preceding vehicle traveling ahead of the own vehicle O is recognized, the traveling ECU 14 may control the constant-vehicle traveling control. In the constant-speed traveling control, the traveling ECU 14 may conduct acceleration or deceleration control on the own vehicle O, based on a target vehicle speed. The target vehicle speed may be a set vehicle speed Vset inputted by a driver who drives the own vehicle O.

The ALKC control and the ELKA control may be conducted, based on the lane-dividing line data included in the traveling environment information. In some embodiments, the traveling ECU 14 may set a target traveling path at the center of the own-vehicle traveling lane and along the left and right lane dividing lines. Based on the target traveling path, the traveling ECU 14 may conduct steering control such as steering feedforward control and steering feedback control. The traveling ECU 14 may thereby maintain the own vehicle O at the center of the lane. When an object such as a vehicle traveling behind the own vehicle O and approaching the own vehicle O is detected on the own-vehicle traveling lane by the left-rear side sensor 18lr or the right-rear side sensor 18rr, the traveling ECU 14 may prohibit the ELKA control.

The ALC control may be conducted based on the lane-dividing line data included in the traveling environment information. In some embodiments, the traveling ECU 14 may set a target lateral position on an adjacent lane next to the own-vehicle traveling lane. Further, the traveling ECU 14 may set a target path extending from a current target route of the own vehicle O to the target lateral position of the own vehicle O. The traveling ECU 14 may perform the steering feedforward control and the steering feedback control along the target path. The traveling ECU 14 may thereby cause the own vehicle O to make a lane change to the adjacent lane. When an object such as a vehicle traveling in parallel to the own vehicle O or a vehicle traveling behind the own vehicle O is detected on the adjacent lane by the left-front side sensor 18lf, the right-front side sensor 18rf, the left-rear side sensor 18lr, or the right-rear side sensor 18rr, the traveling ECU 14 may prohibit the ALC control.

Next, an exemplary process of recognizing the lane dividing line to be conducted by the image recognition ECU 13 will now be described in detail.

In the process of recognizing the lane dividing line according to the present example embodiment, the image recognition ECU 13 may recognize the lane dividing line ahead of the own vehicle O, based on sensing data, which is the captured image of the traveling environment in front of the own vehicle O. Further, the image recognition ECU 13 may perform complementary recognition of the lane dividing line behind the own vehicle O, based on data extracted from the lane dividing line recognized ahead of the own vehicle O.

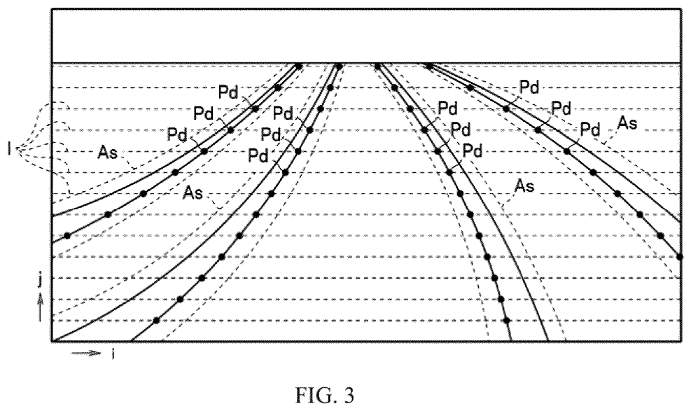

In some embodiments, the image recognition ECU 13 may set a search area As for lane dividing lines to the traveling environment image captured by the main camera 11a, as illustrated in FIG. 3. The search area As may have a predetermined width and extend along the lane dividing line recognized in a previous frame, for example.

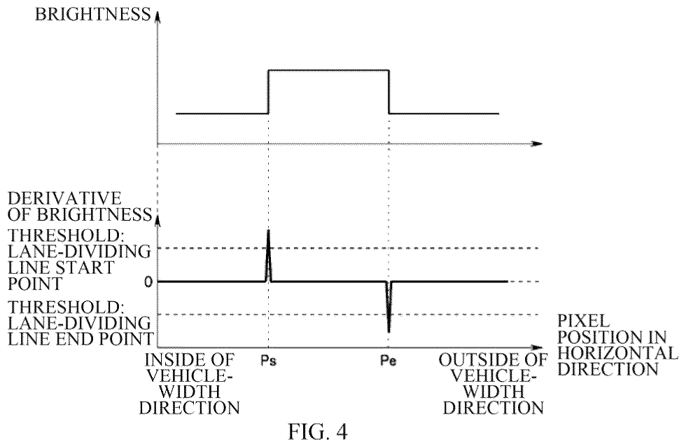

The image recognition ECU 13 may determine a change in brightness in the search area As for each horizontal search line 1 set in the traveling environment image, from inside to outside a vehicle-width direction of the own vehicle O. The image recognition ECU 13 may thereby detect a first edge point where the brightness increases from a low brightness to a high brightness by a predetermined value or greater on each search line 1 within the search area As, as a candidate lane-dividing line point Pd. In some embodiments, the image recognition ECU 13 may detect the first edge point where a derivative of the brightness is greater than or equal to a predetermined threshold, as the candidate lane-dividing line point Pd, as illustrated in FIG. 4.

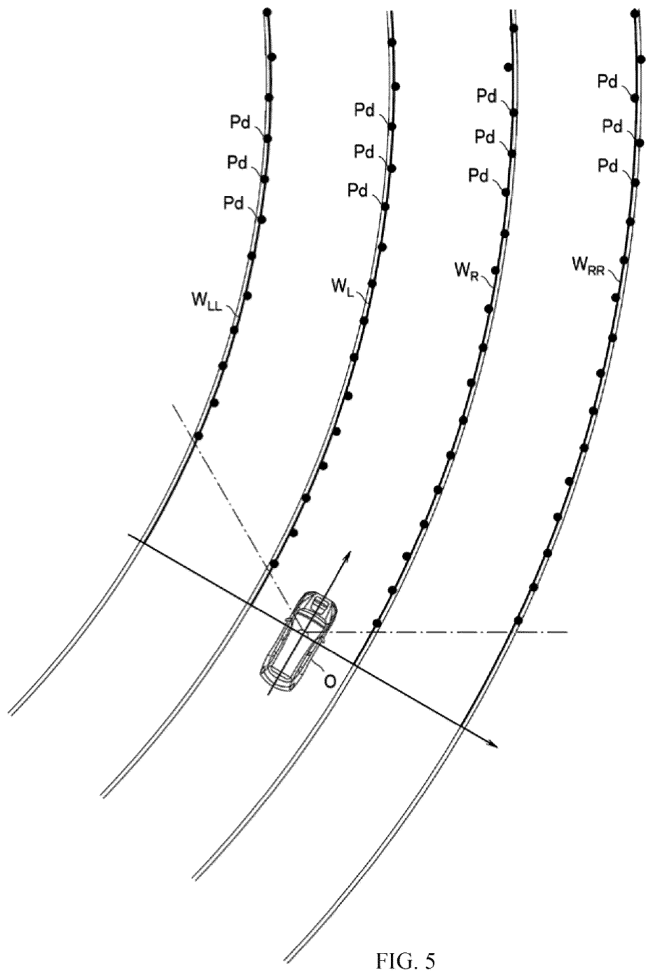

Further, the image recognition ECU 13 may map the candidate lane-dividing line points Pd in a real coordinate space, based on the distance image information, as illustrated in FIG. 5. Based on the group of the candidate lane-dividing line points Pd, the image recognition ECU 13 may calculate a lane-dividing line approximate curve W resembling the lane dividing line. Referring to the example illustrated in FIG. 5, four lane-dividing line approximate curves W_{L}, W_{LL}, W_{R}, and W_{RR} may be calculated based on four groups of the candidate lane-dividing line points Pd.

Through the process described above, the image recognition ECU 13 may recognize the lane dividing line ahead of the own vehicle O.

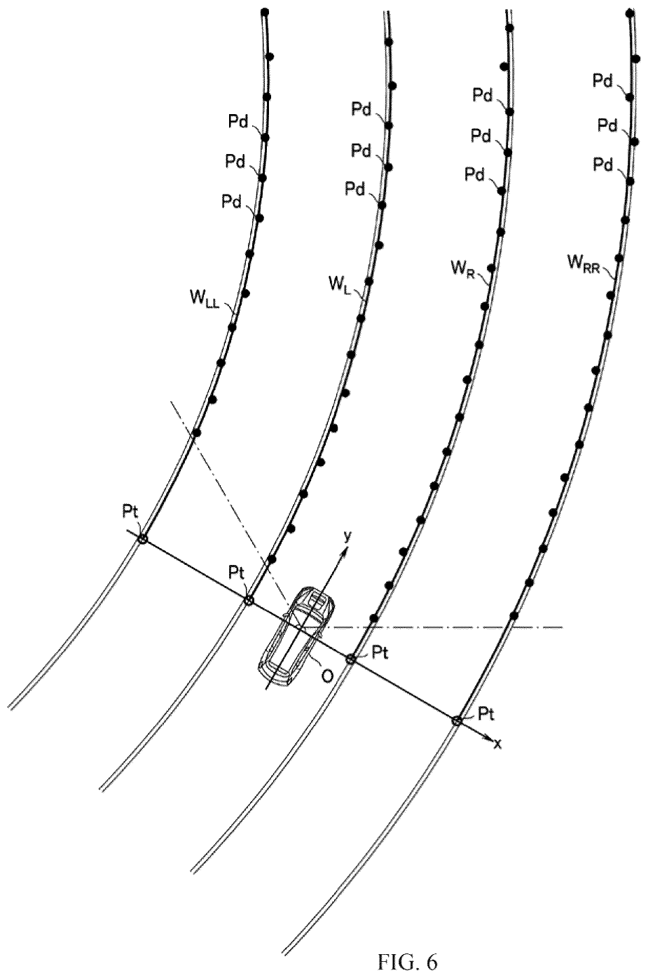

Further, to complement the lane-dividing line by the lane dividing line behind the own vehicle O, the image recognition ECU 13 may extract a currently recognized point on the lane dividing line as a tentative complementary point Pt. In some embodiments, the image recognition ECU 13 may extract the coordinates of a point where the distance from the own vehicle O to each lane-dividing line approximate curve W is shortest, as the tentative complementary point Pt, as illustrated in FIG. 6.

Further, the image recognition ECU 13 may calculate respective relative coordinates (X_{L}, 0), (X_{LL}, 0), (X_{R}, 0), and (X_{RR}, 0) of the tentative complementary points Pt with respect to the own vehicle O. In some embodiments, the image recognition ECU 13 may calculate the coordinates of each tentative complementary point Pt on a relative coordinate system [x-y] having an origin at the own vehicle position, an x-axis along the vehicle-width direction of the own vehicle O, and a y-axis along a longitudinal direction of the own vehicle O. Thereafter, the image recognition ECU 13 may record the relative coordinates of each tentative complementary point Pt. The image recognition ECU 13 may hold the recorded tentative complementary points Pt until a predetermined time period (hereinafter referred to as a frame time t) including a predetermined number of imaging cycles elapses.

Based on the tentative complementary points Pt, the image recognition ECU 13 may calculate a first lane-dividing line complementary point Pc1 and a second lane-dividing line complementary point Pc2. The first lane-dividing line complementary point Pc1 and the second lane-dividing line complementary point Pc2 on the own-vehicle traveling lane and those on an adjacent lane may be calculated by similar calculation methods that are based on the tentative complementary points Pt. To simplify the following description, the method of calculating the first and second lane-dividing line complementary points Pc1 and Pc2 is described simply referring to an example for the own-vehicle traveling lane. In addition, to facilitate understanding of the following description, when these tentative complementary points are to be distinguished from each other, the tentative complementary point on the left lane-dividing line with respect to the own vehicle O is denoted by reference characters starting with L, while the tentative complementary point on the right lane-dividing line with respect to the own vehicle O is denoted by reference characters starting with R, as appropriate.

The first lane-dividing line complementary point Pc1 may be determined by updating the relative coordinates of the tentative complementary point Pt extracted from each frame, based on traveling information on the own vehicle O in each imaging cycle. In some embodiments, the traveling information on the own vehicle O may include the own vehicle speed V and the yaw rate ω acting on the own vehicle O.

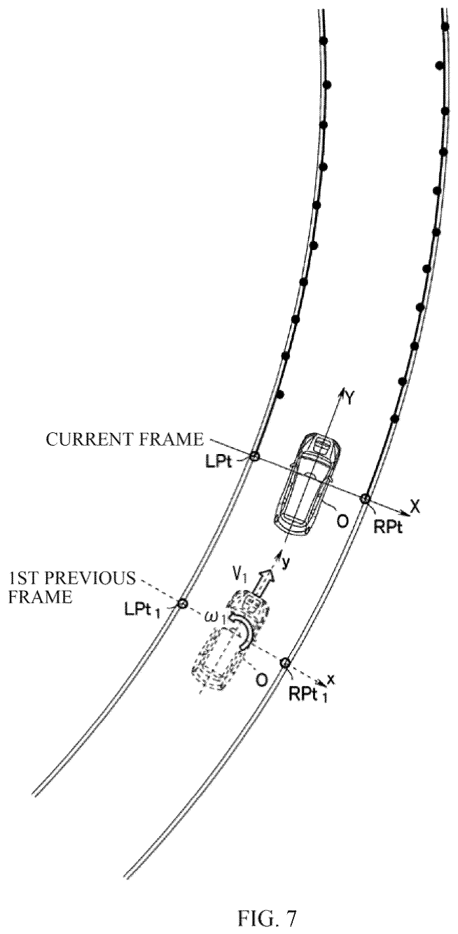

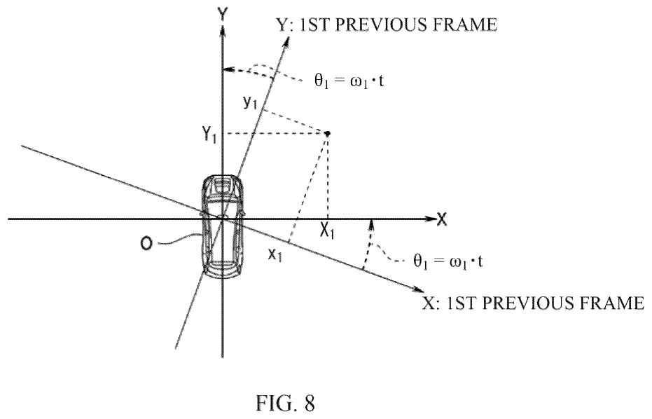

Referring to FIGS. 7 and 8, for example, a moving distance x₁ in an x-axis direction and a moving distance y₁ in a y-axis direction in the current frame viewed from the relative coordinate system [x-y] in the first previous frame may be calculated using the following Expressions 1 and 2.

$${x}_{1} = {V}_{1} sin ( {θ}_{1} ) \cdot t \qquad Expression 1$$

$${y}_{1} = {V}_{1} cos ( {θ}_{1} ) \cdot t \qquad Expression 2$$

In Expressions 1 and 2, “V₁” represents an own vehicle speed in the first previous frame, and “@1” represents a current yaw angle of the own vehicle O viewed from the relative coordinate system [x-y] in the first previous frame. The yaw angle Θ₁ may be calculated by multiplying a yaw rate ω₁ in the first previous frame by the frame time t.

These moving distances x₁ and y₁ viewed from the relative coordinate system [x-y] in the first previous frame may be respectively converted into moving distances X₁ and Y₁ that are based on the relative coordinate system [X-Y] in the current frame, using the following Expressions 3 and 4.

$${X}_{1} = {x}_{1} cos ( {θ}_{1} ) + {y}_{1} sin ( {θ}_{1} ) \qquad Expression 3$$

$${Y}_{1} = - {x}_{1} sin ( {θ}_{1} ) + {y}_{1} cos ( {θ}_{1} ) \qquad Expression 4$$

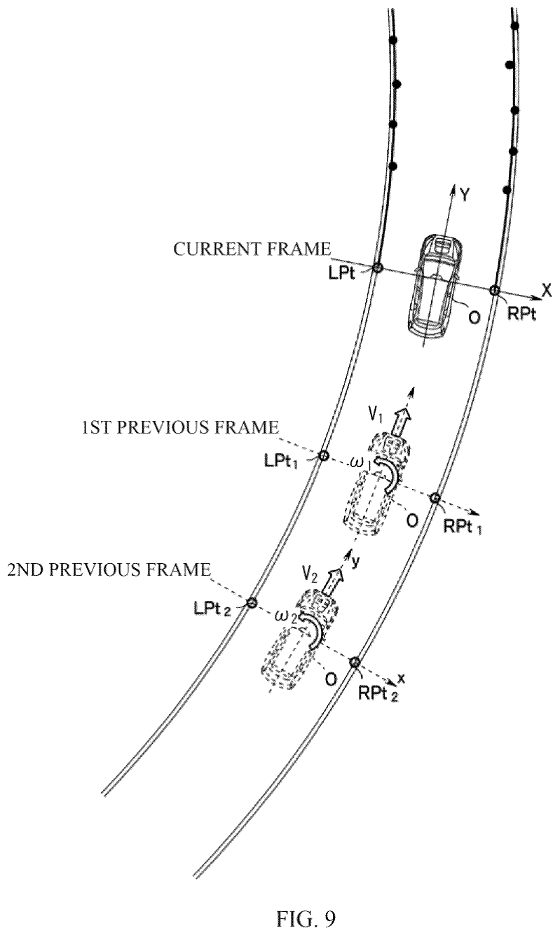

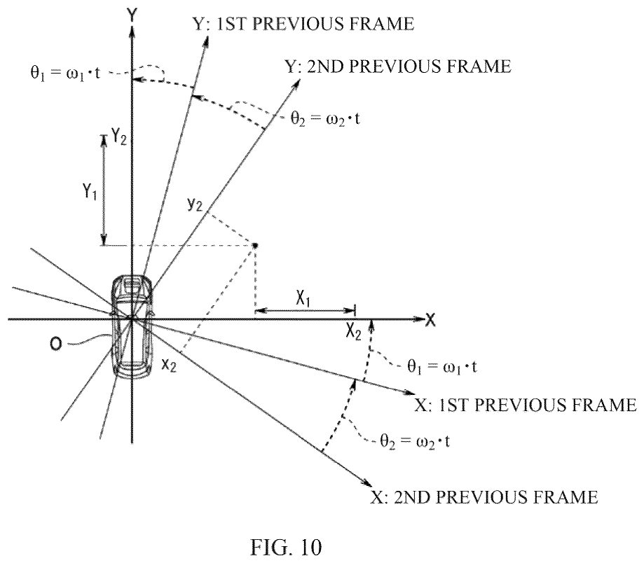

Referring to FIGS. 9 and 10, for example, a moving distance x₂ in the x-axis direction and a moving distance y₂ in the y-axis direction in the first previous frame viewed from the relative coordinate system [x-y] in the second previous frame may be calculated using the following Expressions 5 and 6.

$${x}_{2} = {V}_{2} sin ( {θ}_{2} ) \cdot t \qquad Expression 5$$

$${y}_{2} = {V}_{2} cos ( {θ}_{2} ) \cdot t \qquad Expression 6$$

In Expressions 5 and 6, “V₂” represents an own vehicle speed in the second previous frame, and “Θ₂” represents a yaw angle of the own vehicle O in the first previous frame viewed from the relative coordinate system [x-y] in the second previous frame. The yaw angle Θ₂ may be calculated by multiplying a yaw rate @2 in the second previous frame by the frame time t.

In addition, moving distances X₂ and Y₂ of the own vehicle O from the second previous frame to the current frame may be calculated based on the relative coordinate system [X-Y] in the current frame, using the following Expressions 7 and 8.

$${X}_{2} = {x}_{2} cos ( {θ}_{1} + {θ}_{2} ) + {y}_{2} sin ( {θ}_{1} + {θ}_{2} ) + {X}_{1} \qquad Expression 7$$

$${Y}_{2} = - {x}_{2} sin ( {θ}_{1} + {θ}_{2} ) + {y}_{2} cos ( {θ}_{1} + {θ}_{2} ) + {Y}_{1} \qquad Expression 8$$

Based on the relations described above, moving distances Xₙ and Yₙ of the own vehicle O from the n-th previous frame to the current frame based on the relative coordinate system [X-Y] in the current frame may be generalized, using the following Expressions 9 and 10.

$${X}_{n} = {x}_{n} cos ( {\sum }_{i = 1}^{n} {θ}_{1} ) + {y}_{n} sin ( {\sum }_{i = 1}^{n} {θ}_{1} ) + {X}_{n - 1} \qquad Expression 9$$

$${Y}_{n} = - {x}_{n} sin ( {\sum }_{i = 1}^{n} {θ}_{1} ) + {y}_{n} cos ( {\sum }_{i = 1}^{n} {θ}_{1} ) + {Y}_{n - 1} \qquad Expression 10$$

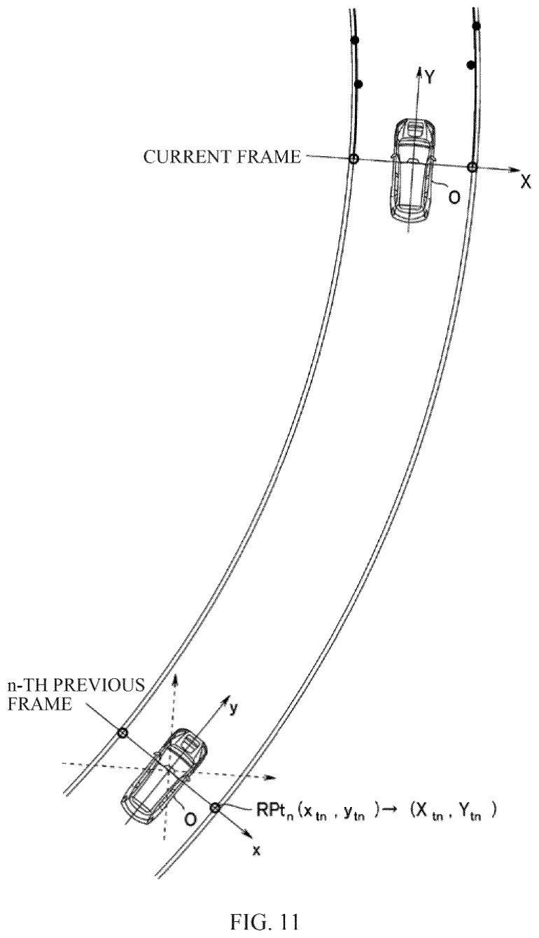

Referring to FIG. 11, for example, coordinates (xₜₙ, yₜₙ) of a tentative complementary point RPtₙ in the n-th previous frame viewed from the relative coordinate system [x-y] in the n-th previous frame may be axially converted into coordinates (Xₜₙ, Yₜₙ) on a coordinate system having the same axial directions as those of the relative coordinate system [X-Y] in the current frame, using the following Expressions 11 and 12.

$${X}_{t n} = {x}_{t n} cos ( {\sum }_{i = 1}^{n} {θ}_{1} ) + {y}_{t n} sin ( {\sum }_{i = 1}^{n} {θ}_{1} ) \qquad Expression 11$$

$${Y}_{t n} = - {x}_{t n} sin ( {\sum }_{i = 1}^{n} {θ}_{1} ) + {y}_{t n} cos ( {\sum }_{i = 1}^{n} {θ}_{1} ) \qquad Expression 12$$

Expressions 13 and 14 described below may be derived from Expressions 9, 10, 11, and 12 described above, as the expressions used to calculate coordinates (X_{Pc1_n}, Y_{Pc1_n}) of a tentative complementary point Ptₙ (i.e., a first lane-dividing line complementary point Pc1ₙ) in the n-th previous frame viewed from the relative coordinate system [X-Y] in the current frame.

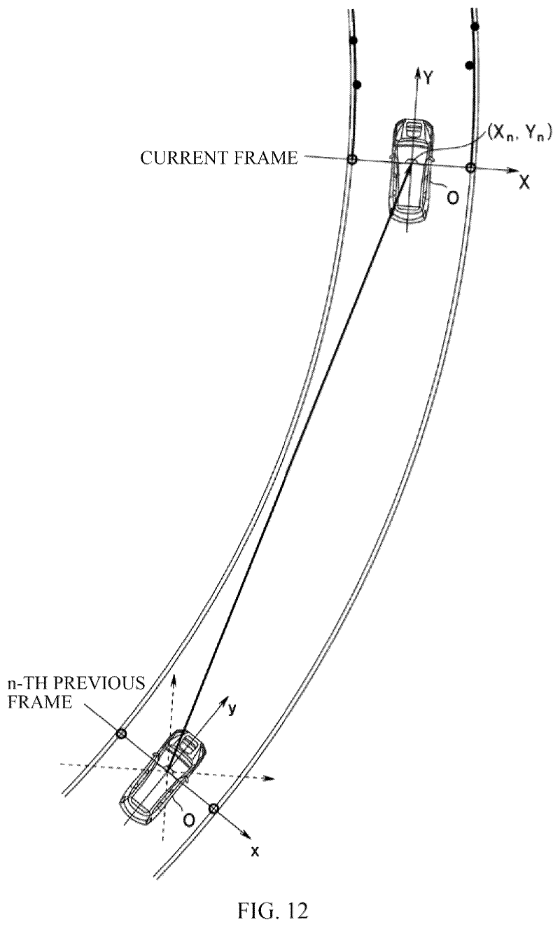

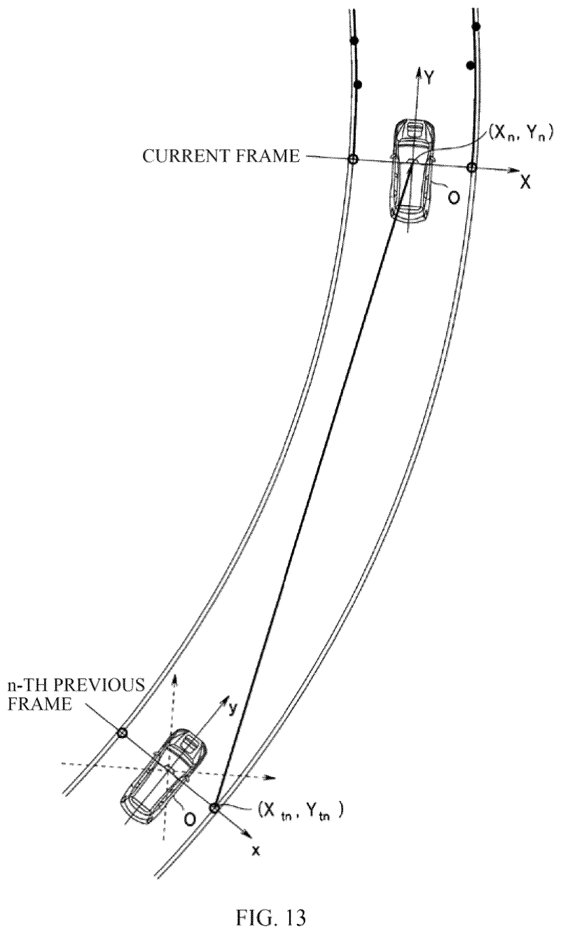

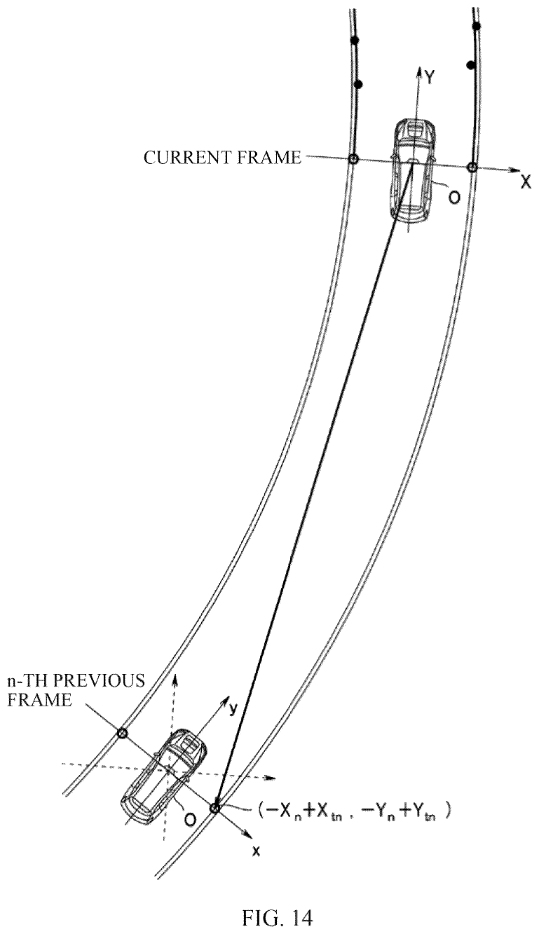

Referring to FIG. 12, for example, coordinates (Xₙ, Yₙ) may indicate a distance to the current own vehicle position (i.e., the origin of the relative coordinate system [X-Y]) viewed from the relative coordinate system [x-y] in the n-th previous frame. In addition, referring to FIG. 13, for example, coordinates (Xₜₙ, Yₜₙ) may indicate a distance to the current own vehicle position viewed from the tentative complementary point RPtₙ on the relative coordinate system [x-y] in the n-th previous frame. Based on these relations described above, the distance from the tentative complementary point RPtₙ to the current own vehicle position (i.e., the origin of the relative coordinate system [X-Y]) may be indicated by coordinate (Xₙ-Xₜₙ, Yₙ-Yₜₙ). Here, referring to FIG. 14, for example, it may be necessary to calculate coordinates indicating the distance to the tentative complementary point RPtₙ in the n-th previous frame viewed from the current own vehicle position. The coordinates indicating the distance from the origin of the relative coordinate system [X-Y] in the current frame to the tentative complementary point RPtₙ in the n-th previous frame may be (−Xₙ+Xₜₙ, −Yₙ+Yₜₙ).

$${X}_{Pc 1 \_ n} = - {X}_{n} + {X}_{t n} \qquad Expression 13$$

$${Y}_{Pc 1 \_ n} = - {Y}_{n} + {Y}_{t n} \qquad Expression 14$$

As apparent from the above-described description, the image recognition ECU 13 may be configured to calculate the first lane-dividing line complementary point Pc1ₙ that is based on the tentative complementary point Pt in the n-th previous frame, using Expressions 13 and 14 described above.

Further, the image recognition ECU 13 may acquire a standard deviation σx and a standard deviation σ_{y}, as evaluation values indicating detection accuracy in detecting the traveling information in the x-axis direction and the y-axis direction. In one embodiment, the standard deviation σₓ and the standard deviation σ_{y} may each serve as a “first evaluation value”. The standard deviation σₓ and the standard deviation σ_{y} may be acquired in each frame. To acquire the standard deviation σₓ and the standard deviation σ_{y}, the image recognition ECU 13 may estimate detection accuracy of the yaw rate sensor 38 in detecting the yaw rate ω and detection accuracy of the vehicle speed sensor 37 in detecting the own vehicle speed V, for example. The detection accuracy may be estimated taking into consideration external factors such as a road shape of an own vehicle traveling road as well as a detection functionality originally owned by the yaw rate sensor 38 and a detection functionality originally owned by the vehicle speed sensor 37. The image recognition ECU 13 may calculate the standard deviation σₓ and the standard deviation σ_{y}, based on one or both of the detection accuracy of the yaw rate sensor 38 in detecting the yaw rate ω and the detection accuracy of the vehicle speed sensor 37 in detecting the own vehicle speed V, referring to a predetermined map, for example.

The second lane-dividing line complementary point Pc2 may be obtained by calculating absolute position data on the tentative complementary point Pt from the relative coordinates of the tentative complementary point Pt extracted from each frame. In this case, the absolute position data may include a latitude and a longitude of the tentative complementary point Pt, for example.

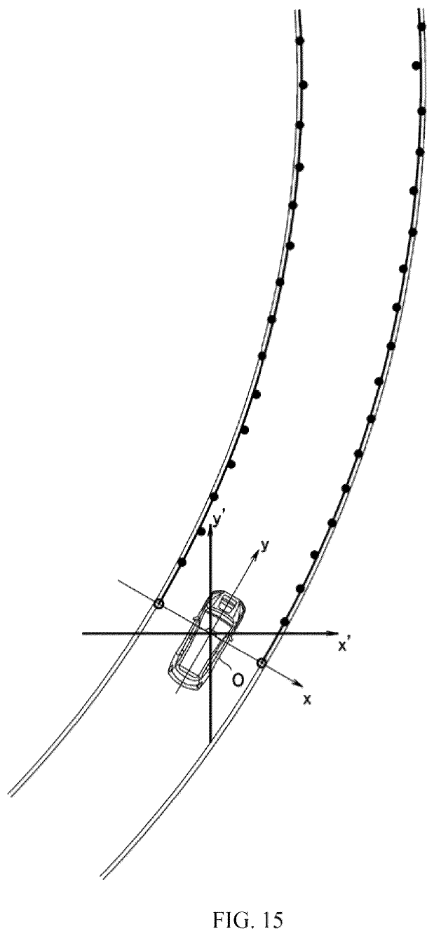

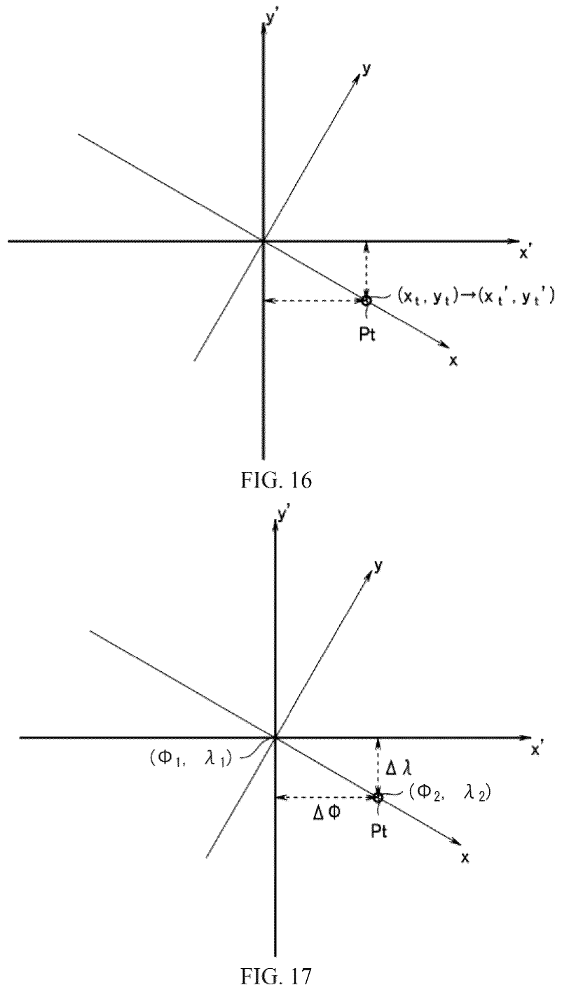

To calculate the latitude and longitude of the tentative complementary point Pt, as illustrated in FIGS. 15 and 16, for example, the image recognition ECU 13 may convert the coordinates of the tentative complementary point Pt in the current frame from the coordinates (xₜ, yₜ) on the relative coordinate system [x-y] into coordinates (xₜ′, yₜ′) on a relative coordinate system [x′-y′].

The relative coordinate system [x-y] may have an origin at the own vehicle position, an x-axis along the vehicle-width direction of the own vehicle O, and a y-axis along the longitudinal direction of the own vehicle O. The relative coordinate system [x′-y′] may have an origin at the own vehicle position, an x′-axis along an east-west direction, and a y′-axis along a north-south direction.

As illustrated in FIG. 17, the image recognition ECU 13 may calculate the absolute position data on the tentative complementary point Pt (a latitude φ2 and a longitude λ2), based on the absolute position data (a latitude φ1 and a longitude λ1) on the own vehicle O received at the GNSS receiver 17a, using the following Expressions 15 to 18.

$$Δλ = {λ}_{2} - {λ}_{1} \qquad Expression 15$$

$$Δφ = {φ}_{2} - {φ}_{1} \qquad Expression 16$$

$${x}^{′} = A \cdot Δλ \cdot cos {φ}_{1} \qquad Expression 17$$

$${y}^{′} = A \cdot Δφ \qquad Expression 18$$

Here, Expressions 17 and 18 may be used to trigonometrically convert the latitude and longitude and the coordinates on the relative coordinate system [x′-y′], assuming that the earth is completely spherical. In Expressions 17 and 18, “A” represents an equatorial radius (=6,378,137 m) of the earth.

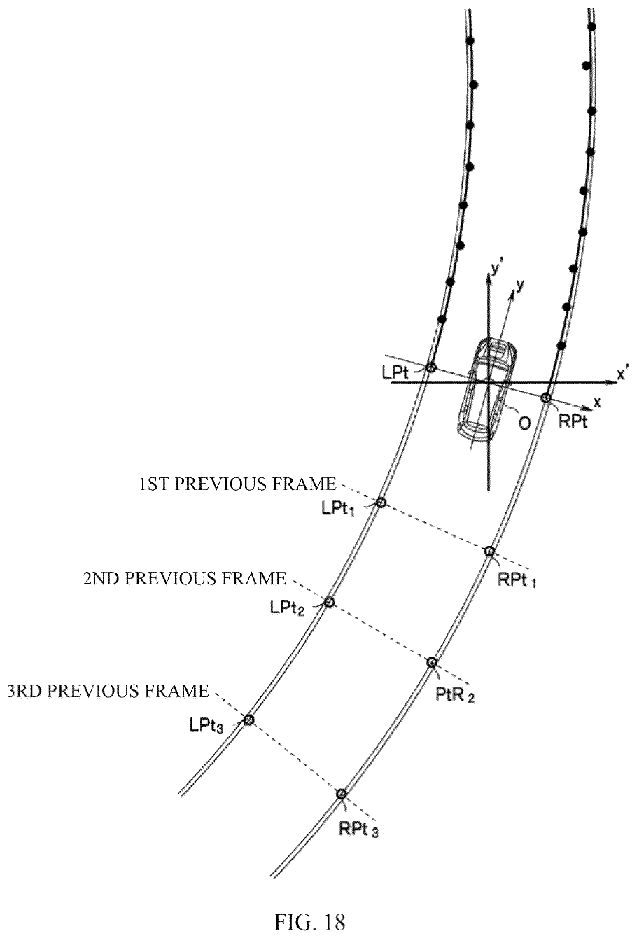

The image recognition ECU 13 may calculate the absolute position data on the tentative complementary point Pt each time the tentative complementary point Pt is extracted (i.e., for each frame). The image recognition ECU 13 may hold the calculated absolute position data on the tentative complementary point Pt until the predetermined time period (frame time t) including the predetermined number of imaging cycles elapses. The image recognition ECU 13 may thereby acquire a sequence of the tentative complementary points Ptₙ including the absolute position data, as illustrated in FIG. 18, for example.

Thereafter, the image recognition ECU 13 may calculate coordinates (xₜₙ′, yₜₙ′) on the relative coordinate system [x′-y′] with reference to the current own vehicle position, based on the absolute position data (a latitude φ2ₙ and a longitude 22n) on each tentative complementary point (Pt)ₙ, using Expressions 15 to 18 described above.

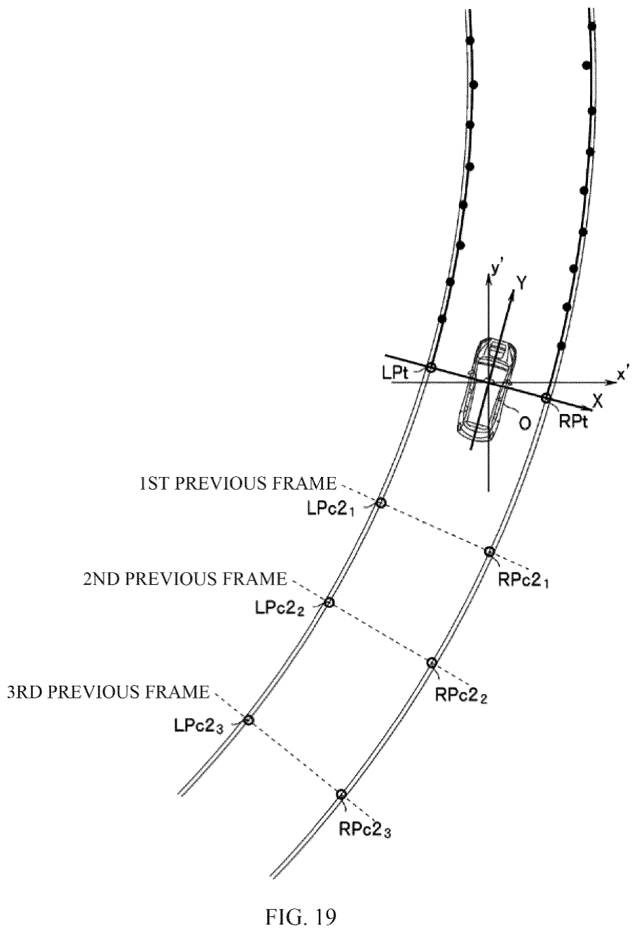

Further, the image recognition ECU 13 may calculate the second lane-dividing line complementary point Pc2ₙ, based on the coordinates (Xₜₙ′, yₜₙ′) of each tentative complementary point Ptₙ, as illustrated in FIG. 19. In some embodiments, the image recognition ECU 13 may convert the coordinates (Xₜₙ′, yₜₙ′) calculated based on the absolute position data on each tentative complementary point Ptₙ in a past frame into the coordinates (Xₜₙ, yₜₙ) on the relative coordinate system [X-Y] in the current frame. The coordinates (Xₜₙ, yₜₙ) obtained as a result of the conversion may correspond to coordinates (X_{Pc2_n}, Y_{Pc2_n}) of the second lane-dividing line complementary point Pc2ₙ.

Further, the image recognition ECU 13 may acquire a standard deviation σ_{z} as an evaluation value indicating detection accuracy of the GNSS receiver 17a in detecting the absolute position data. In one embodiment, the standard deviation σ_{z} may serve as a “second evaluation value”. The standard deviation σ_{z} may be acquired in each frame. To acquire the standard deviation σ_{z}, the image recognition ECU 13 may acquire, from the GNSS receiver 17a, the number of the positioning satellites from which the GNSS receiver 17a has received the positioning signals, and the reception level (signal strength) of the positioning signals, for example. Thereafter, the image recognition ECU 13 may calculate the standard deviation σ_{z}, based on one or both of the number of positioning satellites and the reception level of each positioning signal, referring to a predetermined map, for example. In some embodiments, the standard deviation σ_{z} may be calculated by the GNSS receiver 17a. In this case, the image recognition ECU 13 may acquire the standard deviation σ_{z} calculated by the GNSS receiver 17a for each frame.

Further, the image recognition ECU 13 may calculate reliability K, based on the standard deviations σₓ and σ_{y} each serving as the first evaluation value and the standard deviation σ_{z} serving as the second evaluation value. The reliability K may be used as a coefficient for Kalman filter fusion of the first lane-dividing line complementary point Pc1 and the second lane-dividing line complementary point Pc2 that are calculated based on the tentative complementary point Pt in each frame. The reliability K may be thereby calculated for each frame in which the tentative complementary point Pt has been calculated. In the present example embodiment, the reliability K may be calculated as the degree of reliability of the first lane-dividing line complementary point Pc1 relative to the second lane-dividing line complementary point Pc2, for example. The reliability K may be calculated in each of the x-axis direction and the y-axis direction of the relative coordinate system [X-Y] in the current frame. Hereinafter, the reliability of the first lane-dividing line complementary point Pc1ₙ calculated based on the tentative complementary point Ptₙ in the n-th previous frame may be represented as (Kₓ)ₙ and (K_{y})ₙ.

Prior to the calculation of the reliability (Kₓ)ₙ and (K_{y})ₙ, the image recognition ECU 13 may calculate a variance (σₓ²)ₙ and a variance (σ_{y}²)ₙ of the first lane-dividing line complementary point Pc1ₙ in the n-th previous frame viewed from the current own vehicle position, using the following Expressions 19 and 20.

$${( {{σ}_{x}}^{2} )}_{n} = {\sum }_{i = 1}^{n} {( {{σ}_{x}}^{2} )}_{i} \qquad Expression 19$$

$${( {{σ}_{y}}^{2} )}_{n} = {\sum }_{i = 1}^{n} {( {{σ}_{y}}^{2} )}_{i} \qquad Expression 20$$

Further, the image recognition ECU 13 may calculate a variance (σ_{z}²)ₙ of the second lane-dividing line complementary point Pc2ₙ in the n-th previous frame viewed from the current own vehicle position, using the following Expression 21.

$${( {{σ}_{z}}^{2} )}_{n} = {{σ}_{z \_ current}}^{2} + {{σ}_{z \_ nF}}^{2} \qquad Expression 21$$

In Expression 21, “σ_{z_current}” represents a standard deviation in the current frame, and “O_{z_nF}” represents a standard deviation in the n-th previous frame.

Further, the image recognition ECU 13 may calculate reliability (Kₓ)ₙ and (K_{y})ₙ of the first lane-dividing line complementary point Pc1ₙ, based on a variance (σₓ²)ₙ of the first lane-dividing line complementary point Pc1ₙ in the n-th previous frame and a variance (σ_{z}²)ₙ of the second lane-dividing line complementary point Pc2ₙ in the n-th previous frame, using the following Expressions 22 and 23.

$${( {K}_{x} )}_{n} = \frac{{( {{σ}_{x}}^{2} )}_{n}}{{( {{σ}_{x}}^{2} )}_{n} + {( {{σ}_{x}}^{2} )}_{n}} \qquad Expression 22$$

$${( {K}_{y} )}_{n} = \frac{{( {{σ}_{y}}^{2} )}_{n}}{{( {{σ}_{y}}^{2} )}_{n} + {( {{σ}_{x}}^{2} )}_{n}} \qquad Expression 23$$

Thereafter, the image recognition ECU 13 may calculate a fusion value (uₓ, u_{y})ₙ of the coordinates (X_{Pc1_n}, Y_{Pc1_n}) of the first lane-dividing line complementary point Pc1ₙ in the n-th previous frame and the coordinates (X_{Pc2_n}, Y_{Pc2_n}) of the second lane-dividing line complementary point Pc2ₙ in the n-th previous frame, based on the reliability (Kₓ)ₙ and (K_{y})ₙ of the first lane-dividing line complementary point Pc1ₙ, using the following Expressions 24 and 25.

$${( {u}_{x} )}_{n} = {( {K}_{x} )}_{n} \cdot ( {X}_{Pc 1 \_ n} ) + [ 1 - {( {K}_{y} )}_{n} ] \cdot ( {X}_{Pc 2 \_ n} ) \qquad Expression 24$$

$${( {u}_{y} )}_{n} = {( {K}_{y} )}_{n} \cdot ( {Y}_{Pc 1 \_ n} ) + [ 1 - {( {K}_{y} )}_{n} ] \cdot ( {Y}_{Pc 2 \_ n} ) \qquad Expression 25$$

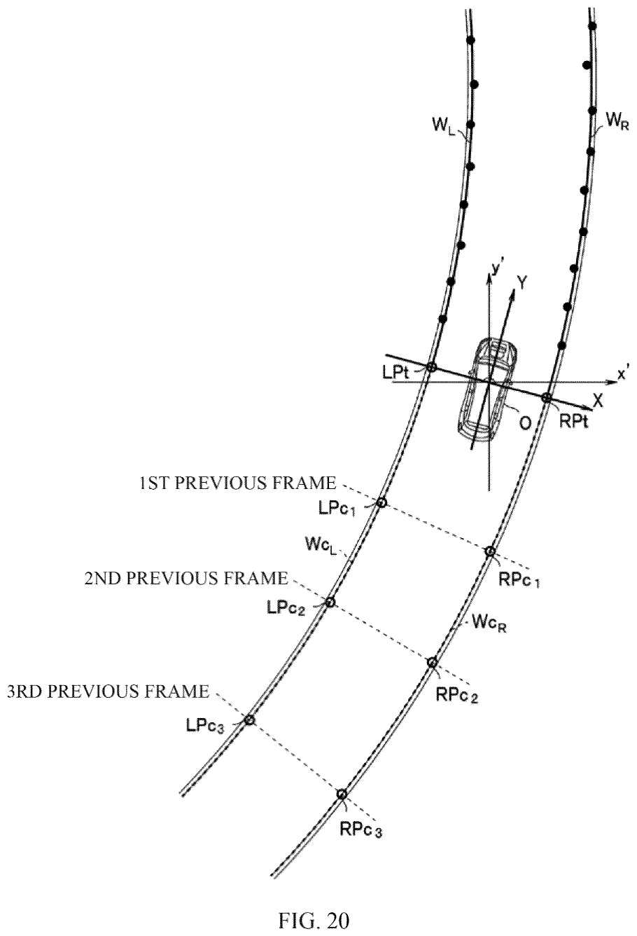

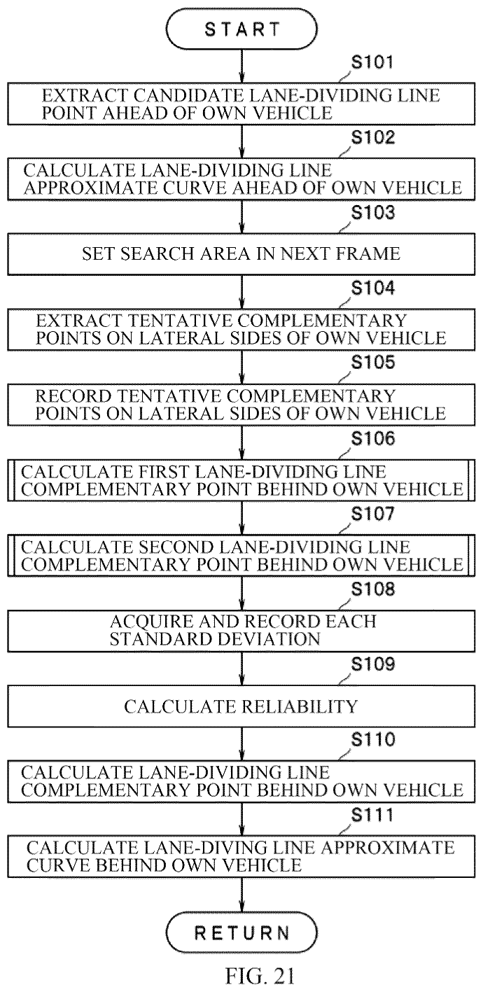

The fusion value (uₓ, u_{y})ₙ may correspond to the coordinates of a final lane-dividing line complementary point Pcₙ obtained by integrating the first lane-dividing line complementary point Pc1ₙ and the second lane-dividing line complementary point Pc2ₙ that are based on the tentative complementary point Ptₙ in the n-th previous frame, as illustrated in FIG. 20. Based on the group of the lane-dividing line complementary points PCₙ, the image recognition ECU 13 may calculate a lane-dividing line approximate curve W_{c} (W_{CL}, W_{CR}) behind the own vehicle O that complements the lane-dividing line approximate curve W.

In one embodiment, the image recognition ECU 13 may serve as a “lane-dividing line recognizer”, a “relative coordinate calculator”, a “first complementary point calculator”, a “first evaluation value acquirer”, a “second complementary point calculator”, a “second evaluation value acquirer”, and a “complementary point integrator”.

Next, the process of recognizing the lane dividing line will be described with reference to a flowchart of a lane-dividing line recognition routine illustrated in FIG. 21. The image recognition ECU 13 may execute the routine in each predetermined time (e.g., in each imaging cycle of the stereo camera 11).

When the routine starts, in Step S101, the image recognition ECU 13 may extract, as the lane-dividing line data, the candidate lane-dividing line point Pd ahead of the own vehicle O, based on the traveling environment image, as illustrated in FIG. 3.

Thereafter, in Step S102, the image recognition ECU 13 may calculate, as the lane-dividing line data, the lane-dividing line approximate curve W, based on the group of the candidate lane-dividing line point Pd thus extracted, as illustrated in FIG. 5.

Thereafter, in Step S103, the image recognition ECU 13 may set the search area As in the next frame, based on the lane-dividing line approximate curve W thus calculated.

Thereafter, in Step S104, the image recognition ECU 13 may extract the tentative complementary points Pt on lateral sides of the own vehicle O, based on the lane-dividing line data. In some embodiments, the image recognition ECU 13 may extract, as the tentative complementary point Pt, an intersection between the x-axis of the relative coordinate system [x-y] with respect to the own vehicle position and each lane-dividing line approximate curve W, as illustrated in FIG. 6. Thereafter, the image recognition ECU 13 may calculate the coordinates of each extracted tentative complementary point Pt on the relative coordinate system [x-y].

Thereafter, in Step S105, the image recognition ECU 13 may record the coordinates of each extracted tentative complementary point Pt.

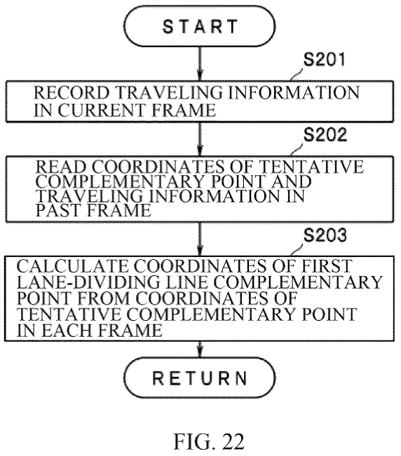

Thereafter, in Step S106, the image recognition ECU 13 may calculate the first lane-dividing line complementary point Pc1, based on each tentative complementary point Pt extracted from each frame. The first lane-dividing line complementary point Pc1 may be calculated according to a flowchart, illustrated in FIG. 22, of a sub-routine of the calculation of the first lane-dividing line complementary point Pc1, for example.

When the sub-routine starts, in Step S201, the image recognition ECU 13 may record the traveling information, such as the yaw rate ω and the own vehicle speed V, on the own vehicle O in the current frame.

Thereafter, in Step S202, the image recognition ECU 13 may read the coordinates of the tentative complementary point Pt and the traveling information in a past frame.

Thereafter, in Step S203, the image recognition ECU 13 may calculate the coordinates of the first lane-dividing line complementary point Pc1ₙ from the coordinates of each tentative complementary point Ptₙ in each frame, using Expressions 9 to 14 described above, following which the procedure may exit the sub-routine.

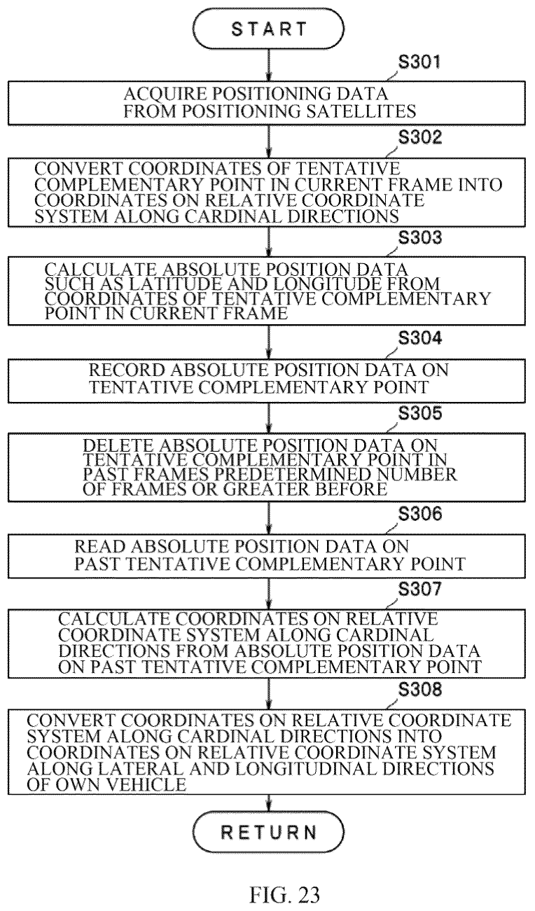

When the procedure proceeds from Step S106 to S107 in the main routine illustrated in FIG. 21, the image recognition ECU 13 may calculate the second lane-dividing line complementary point Pc2, based on each tentative complementary point Pt extracted from each frame. The second lane-dividing line complementary point Pc2 may be calculated according to a flowchart, illustrated in FIG. 23, of a sub-routine of the calculation of the second lane-dividing line complementary point, for example.

When the sub-routine starts, in Step S301, the image recognition ECU 13 may acquire positioning data from the positioning satellites. In some embodiments, the image recognition ECU 13 may acquire the absolute position data, such as the latitude, longitude, and azimuth angle of the own vehicle O.

Thereafter, in Step S302, the image recognition ECU 13 may convert the coordinates of the tentative complementary point Pt in the current frame from the coordinates on the relative coordinate system [x-y] having axial directions along the longitudinal and lateral directions of the own vehicle O into the coordinates on the relative coordinate system [x′-y′] having axial directions along the cardinal directions.

Thereafter, in Step S303, the image recognition ECU 13 may calculate the absolute position data, such as the latitude and the longitude, of the tentative complementary point Pt from the coordinates of the tentative complementary point Pt in the current frame. In some embodiments, the image recognition ECU 13 may calculate the absolute position data on the tentative complementary point Pt, based on the absolute position data on the own vehicle O, using Expressions 15 to 18 described above.

Thereafter, in Step S304, the image recognition ECU 13 may record the absolute position data on the tentative complementary point Pt.

Thereafter, in Step S305, the image recognition ECU 13 may delete the absolute position data on the tentative complementary points Pt in the past frames a predetermined number of frames or greater before, from the absolute position data on the tentative complementary points Pt currently recorded.

Thereafter, in Step S306, the image recognition ECU 13 may read the absolute position data on the tentative complementary points Pt in a past frame.

Thereafter, in Step S307, the image recognition ECU 13 may calculate the coordinates of the tentative complementary point Pt on the relative coordinate system [x′-y′] from the absolute position data on the tentative complementary point Pt in each frame. In some embodiments, the image recognition ECU 13 may calculate the coordinates of each tentative complementary point Pt on the relative coordinate system [x′-y′], based on the absolute position data on the own vehicle O, using Expressions 15 to 18 described above.

Thereafter, in Step S308, the image recognition ECU 13 may convert the coordinates of each tentative complementary point Pt from coordinates on the relative coordinate system [x′-y′] having axial directions along the cardinal directions into coordinates on the relative coordinate system [x-y] having axial directions along the longitudinal and lateral directions of the own vehicle O, following which the procedure may exit the sub-routine.

When the procedure proceeds from Step S107 to S108 in the main routine illustrated in FIG. 21, the image recognition ECU 13 may acquire the standard deviations ox and σ_{y} for the current traveling information and the standard deviation σ_{z} for the current absolute position data, and record the standard deviation σₓ, the standard deviation σ_{y}, and the standard deviation σ_{z}.

Thereafter, in Step S109, the image recognition ECU 13 may read the standard deviation σₓ, the standard deviation σ_{y}, and the standard deviation σ_{z} for each frame, and calculate the reliability (Kₓ) and (K_{y}) of the first lane-dividing line complementary point Pc1 in each frame, using Expressions 22 and 23 described above.

Thereafter, in Step S110, the image recognition ECU 13 may calculate the fusion value (uₓ, u_{y}) as the coordinates of the lane-dividing line complementary point Pc. In some embodiments, the image recognition ECU 13 may calculate the fusion value (uₓ, u_{y}) of the coordinates (X_{Pc1}, Y_{Pc1}) of the first lane-dividing line complementary point Pc1 and the coordinates (X_{Pc2}, Y_{Pc2}) of the second lane-dividing line complementary point Pc2 that are based on the tentative complementary point Pt in each frame, using Expressions 24 and described above.

Thereafter, in Step S111, the image recognition ECU 13 may calculate the lane-dividing line approximate curve W_{c} (W_{CL} and W_{CR}) behind the own vehicle O, based on the group of the lane-dividing line complementary points Pc thus calculated, following which the procedure may exit the routine.

In the example embodiment described above, the image recognition ECU 13 recognizes the lane-dividing line data in each predetermined cycle (in each frame cycle), based on the image of the traveling environment in front of the own vehicle O, and calculates the relative coordinates of the tentative complementary point Pt with respect to the own vehicle O. Further, the image recognition ECU 13 updates the relative coordinates of the tentative complementary points Pt having been calculated, based on the traveling information, such as the yaw rate ω and the own vehicle speed V, of the own vehicle O in each predetermined cycle, and calculates the first lane-dividing line complementary point Pc1 usable for complementing the lane-dividing line data by the data on the lane-dividing line behind the own vehicle O. Further, the image recognition ECU 13 acquires the standard deviations σₓ and σ_{y} as the evaluation values usable for evaluating the detection accuracy of the traveling information on the own vehicle O, in each predetermined cycle. Further, the image recognition ECU 13 calculates the absolute position data on the tentative complementary point Pt, based on the absolute position data, such as the latitude, the longitude, and the azimuth angle, of the own vehicle O measured using the positioning signals from the positioning satellites, and calculates the second lane-dividing line complementary point usable for complementing the lane-dividing line data by the data on the lane-dividing line behind the own vehicle O, based on the absolute position data on the tentative complementary points Pt having been calculated and the absolute position data on the own vehicle O currently calculated. Further, the image recognition ECU 13 acquires the standard deviation σ_{z} as the evaluation value usable for evaluating the detection accuracy of the absolute position data on the own vehicle O, in each predetermined cycle. The image recognition ECU 13 calculates a final lane-dividing line complementary point Pc by integrating the first lane-dividing line complementary point Pc1 and the second lane-dividing line complementary point Pc2, using the reliability calculated based on the standard deviations σₓ and σ_{y} and the standard deviation σ_{z}. It is therefore possible to generate accurate complementary data on the lane-dividing line in the area behind the own vehicle O, based on the lane-dividing line data on the area in front of the own vehicle O.

The image recognition ECU 13 calculates the first lane-dividing line complementary point Pc1 and the second lane-dividing line complementary point Pc2 from the relative coordinates of the tentative complementary point Pt extracted from the lane-dividing line data on the area in front of the own vehicle O, based on the traveling information on the own vehicle O detected by the in-vehicle sensor and the absolute position data on the own vehicle O measured using the positioning satellites. Thereafter, the image recognition ECU 13 calculates the reliability, based on the evaluation values (standard deviations σₓ and σ_{y}) usable for evaluating the detection accuracy of the traveling information on the own vehicle O, and the evaluation value (standard deviation σ_{z}) usable for evaluating the detection accuracy of the absolute position data on the own vehicle O, and calculates the candidate lane-dividing line point Pd by integrating the first lane-dividing line complementary point Pc1 and the second lane-dividing line complementary point Pc2, based on the degree of contribution depending on the reliability. Accordingly, when a detection error of the traveling information on the own vehicle O is large, for example, it is possible to complement a decrease in the accuracy in calculating the first lane-dividing line complementary point Pc1 by the second lane-dividing line complementary point Pc2. Likewise, when the detection error of the absolute position data on the own vehicle O is large, for example, it is possible to complement a decrease in the accuracy in calculating the second lane-dividing line complementary point Pc2 by the first lane-dividing line complementary point Pc1. It is therefore possible to generate accurate complementary data on the lane-dividing line in the area behind the own vehicle O.

Generating the accurate complementary data on the lane-dividing line in the area behind the own vehicle O makes it possible to properly determine the lane on which another vehicle is traveling behind the own vehicle during the execution of the ELKA control or the ALC control.

In the foregoing example embodiment, the image recognition ECU 13, the traveling ECU 14, the E/G_ECU 22, the T/M_ECU 23, the BK_ECU 24, and the PS_ECU may each include a known microcomputer and a peripheral device. The microcomputer may include a central processing unit (CPU), a random-access memory (RAM), a read-only memory (ROM), and a nonvolatile memory. The ROM may hold a program to be executed by the CPU and fixed data such as a data table, for example. All or a part of the functionality of these processors may be logic circuitry or analog circuitry, or may be implemented by electronic circuitry such as a field programmable gate array (FPGA).

The technology described above is not limited to the foregoing example embodiments, and various modifications may be made in the implementation stage without departing from the gist of the technology. Further, the foregoing example embodiments each include various stages of the technology, and various technologies may be extracted by appropriately combining the features of the technology disclosed herein.

For example, in a case where the above-described problems may be addressed and the above-described effects may be obtained even if some features are deleted from all the features disclosed herein, the remaining features may be extracted as a technology.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a”, “an”, and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. do not denote any order or importance, but rather the terms first, second, etc. are used to distinguish one element from another. The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

The image recognition ECU 13 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the image recognition ECU 13 illustrated in FIG. 1. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the image recognition ECU 13 illustrated in FIG. 1.

What is claimed is:

1. A lane-dividing line recognition apparatus for a vehicle, the lane-dividing line recognition apparatus comprising:
a lane-dividing line recognizer configured to recognize data on a lane dividing line ahead of the vehicle in each of predetermined cycles, based on sensing data on a traveling environment in front of the vehicle;
a relative coordinate calculator configured to extract a tentative complementary point from the data on the lane dividing line in each of the predetermined cycles, and calculate relative coordinates of the tentative complementary point with respect to the vehicle;
a first complementary point calculator configured to update the relative coordinates of the tentative complementary point having been calculated, based on traveling information on the vehicle in each of the predetermined cycles, and calculate a first lane-dividing line complementary point usable for complementing the data on the lane dividing line by data on a lane dividing line behind the vehicle;
a first evaluation value acquirer configured to acquire a first evaluation value usable for evaluating accuracy in detecting the traveling information in each of the predetermined cycles;
a second complementary point calculator configured to calculate absolute position data on the tentative complementary point from the relative coordinates of the tentative complementary point, based on absolute position data on the vehicle measured using signals from positioning satellites in each of the predetermined cycles, and calculate a second lane-dividing line complementary point usable for complementing the data on the lane dividing line by the data on the lane dividing line behind the vehicle, from the absolute position data on the tentative complement point having been extracted and the absolute position data on the vehicle currently measured;
a second evaluation value acquirer configured to acquire a second evaluation value usable for evaluating accuracy in detecting the absolute position data on the vehicle in each of the predetermined cycles; and
a complementary point integrator configured to integrate the first lane-dividing line complementary point and the second lane-dividing line complementary point corresponding to each other, using reliability calculated based on the first evaluation value and the second evaluation value.

2. The lane-dividing line recognition apparatus according to claim 1, further comprising:
a yaw rate detector configured to detect, as the traveling information, a yaw rate acting on the vehicle; and
a vehicle speed detector configured to detect, as the traveling information, a vehicle speed of the vehicle, wherein
the first evaluation value acquirer is configured to calculate the first evaluation value, based on one or both of detection accuracy of the yaw rate detector and detection accuracy of the vehicle speed detector that vary depending on the traveling environment.

3. The lane-dividing line recognition apparatus according to claim 1, wherein the second evaluation value acquirer is configured to calculate the second evaluation value, based on one or both of a number of the positioning satellites used in measuring the absolute position data and strength of the signals from the positioning satellites.

4. A lane-dividing line recognition apparatus for a vehicle, the lane-dividing line recognition apparatus comprising
a processor configured to
recognize data on a lane dividing line ahead of the vehicle in each of predetermined cycles, based on sensing data on a traveling environment in front of the vehicle,
extract a tentative complementary point from the data on the lane dividing line in each of the predetermined cycles, and calculate relative coordinates of the tentative complementary point with respect to the vehicle,
update the relative coordinates of the tentative complementary point having been calculated, based on traveling information on the vehicle in each of the predetermined cycles, and calculate a first lane-dividing line complementary point usable for complementing the data on the lane dividing line by data on a lane dividing line behind the vehicle,
acquire a first evaluation value usable for evaluating accuracy in detecting the traveling information in each of the predetermined cycles,
calculate absolute position data on the tentative complementary point from the relative coordinates of the tentative complementary point, based on absolute position data on the vehicle measured using signals from positioning satellites in each of the predetermined cycles, and calculate a second lane-dividing line complementary point usable for complementing the data on the lane dividing line by the data on the lane dividing line behind the vehicle, from the absolute position data on the tentative complement point having been extracted and the absolute position data on the vehicle currently measured,
acquire a second evaluation value usable for evaluating accuracy in detecting the absolute position data on the vehicle in each of the predetermined cycles, and
integrate the first lane-dividing line complementary point and the second lane-dividing line complementary point corresponding to each other, using reliability calculated based on the first evaluation value and the second evaluation value.
